(19) United States
(12) Patent Application Publication
(10) Pub. No.: US 2015/0369129 A1
(43) Pub. Date: Dec. 24, 2015

(54) FACILITY WITH A GAS TURBINE AND METHOD FOR REGULATING SAID FACILITY

(71) Applicant: DALKIA, Saint-André-Lez-Lille (FR)

(72) Inventors: Khalil SAIKALY, Mantes La Ville (FR); Benjamin LAULAN, Mantes La Jolie (FR); Damien MENARD, Aigleville (FR); Delphine THOREL, Nanterre (FR); Sofiene KACHROUDI, Paris (FR)

(21) Appl. No.: 14/764,987

(22) PCT Filed: Feb. 4, 2014
(86) PCT No.: PCT/EP2014/052105

§ 371 Date: Jul. 31, 2015

(30) Foreign Application Priority Data
Feb. 4, 2013 (FR) 1350936

(51) Int. Cl. F02C 7/143; F25B 7/00

(52) U.S. Cl. CPC F02C 7/143; F25B 7/00

(57) ABSTRACT

The invention relates to an installation with a gas turbine, comprising:
a refrigerating machine (100) comprising:
   a high pressure circuit (110) with a generator (114) fed by a pump (112) and subjected to a heat source;
   a low pressure circuit (120) with an evaporator (108) fed by an expander member (106) and forming a first cold source; and
   an intermediate pressure circuit (130) with an ejector (102) and a condenser (104) placed downstream from said ejector (102);
a gas turbine (200) with a compressor (202) in which the air feed pipe (210) of the compressor is subjected to a cold source and the exhaust pipe (212) for the exhaust gas forms part of said heat source.

The invention is applicable to producing electricity by stationary co-generation.

The present invention relates to the field of gas turbines, and in particular to improving the energy efficiency of installations with gas turbines. In particular, but in non-limiting manner, the present invention relates to producing electricity by stationary co-generation.

In the above field, numerous techniques have been described for cooling the air at the inlet to a gas turbine (combustion turbine inlet air cooling or CTIAC).

In those techniques for cooling air at the inlet to a gas turbine, various problems are encountered.

Thus, for systems that spray water (using a fogging and evaporative cooler), the amount of cooling possible is limited by outside conditions: the quantity of water that air can contain is limited. For example, in a humid environment, cooling is (almost) impossible.

For mechanical compression systems, the limit on cooling associated with outside conditions does not exist. However, the machine consumes a large amount of electricity: in order to produce 1 kilowatt hour (kWh) of “cold”, it consumes 0.2 kWh to 0.4 kWh of electricity.

Likewise, with absorption systems, there is no limit on cooling associated with outside conditions, and the machine consumes little electricity. In order to produce 1 kWh of “cold”, it consumes 0.07 kWh to 0.1 kWh of electricity. However, such machines are expensive and not very flexible in use.

An object of the present invention is to provide an installation with a gas turbine enabling the drawbacks of the prior art to be overcome and in particular enabling the available mechanical power, and possibly also the available thermal power, supplied by the gas turbine to be increased, with it being possible to adapt to variations in the surrounding atmospheric conditions in which the installation is to be found.

To this end, in a first aspect, the present invention provides an installation with a gas turbine performing CTIAC cooling using a refrigerating machine with an ejector.

More precisely, the invention provides an installation with a gas turbine, the installation being characterized in that it comprises:
a refrigerating machine operating with a fluid (a liquid, e.g. water, or a gas, or more generally a fluid suitable for changing phase, which fluid is in the liquid phase or the gas phase as a function of its position in the machine) the machine comprising:
   a high pressure circuit with a generator fed by a pump and subjected to a heat source;
   a low pressure circuit with an evaporator fed by an expander member and forming a first cold source; and
   an intermediate pressure circuit with an ejector and a condenser placed downstream from said ejector;

wherein the fluid leaving the generator and the fluid leaving the evaporator feed said ejector, and the fluid leaving the condenser feeds said pump and said expander member; and
a gas turbine with a compressor fed with air by an air feed pipe and having its outlet connected to the inlet of a combustion chamber fed with fuel (e.g. natural gas), the output from the combustion chamber being connected to the inlet of a turbine presenting an outlet with exhaust gas flowing in an exhaust pipe;

wherein the air feed pipe is subjected to a cold source and the exhaust pipe forms part of said heat source.

The CTIAC by an ejector refrigerating machine of the invention enables the air at the inlet of the turbine to be cooled to any temperature value, within the limit set by condensation and icing phenomena, and regardless of outside conditions (temperature, humidity, . . . ), even though the performance of such a system (thermal coefficients of performance (COP) and electrical performance) varies with outside conditions.

In addition, the CTIAC by an ejector refrigerating machine of the invention operates from heat rejected from a gas turbine, so its electrical energy consumption is practically negligible.

Furthermore, the CTIAC by an ejector refrigerating machine of the invention operates on the basis of heat that is rejected from a gas turbine at low temperatures, down to about 80° C.

Furthermore, the CTIAC by an ejector refrigerating machine of the invention is more flexible than an absorption system making use of the H₂O/LiBr couple and it presents an acceptable cost that is less than that of a system making use of the NH₃/H₂O couple.

Thus, having recourse to an ejector makes it possible to overcome the drawbacks of conventional gas turbine cooling systems: there is no cooling limit associated with outside conditions, the amount of electricity consumed is small (comparable to using absorption), and implementing this technique is less expensive and more flexible than implementing the absorption technique.

An ejector such as that described in Document WO 2011/006251 may be used in the context of the present invention.

In the above, either the exhaust pipe forms the heat source or else it contributes as one of the components of the heat source.

Furthermore, in a second aspect, the invention provides a regulation method adapted for an installation with a gas turbine as described above.

The application of such a regulation method to an installation with a gas turbine that performs CTIAC by an ejector refrigerating machine is capable of adapting to variations in outside conditions, to variations in the loads on the system (heat demand, electricity demand), while optimizing operation of the ejector.

Other advantages and characteristics of the invention appear on reading the following description given by way of example with reference to the accompanying drawings, in which:

FIG. 1 is a diagrammatic view showing an installation of the invention with a gas turbine;

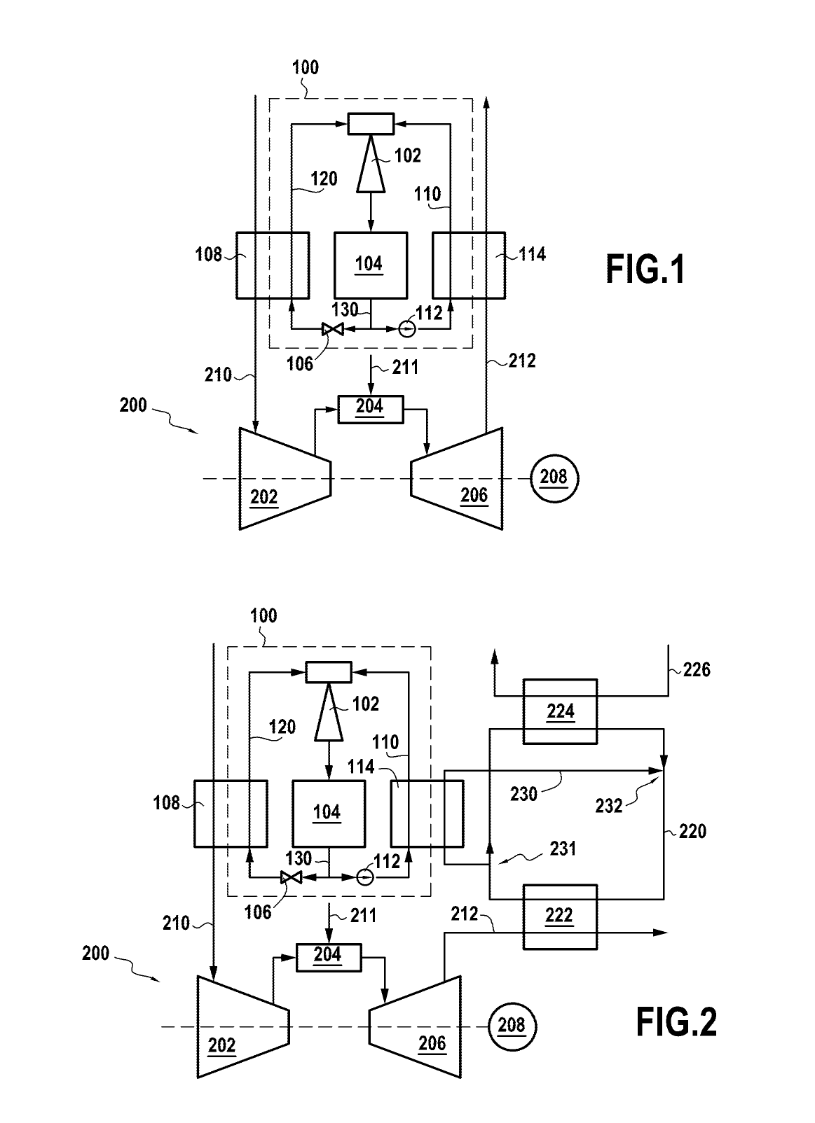

FIGS. 2 to 5 show variant embodiments of the installation of the invention with a gas turbine;

FIGS. 6 to 8 show various possible configurations for implementing the installation of the invention with a gas turbine within a heating network; and

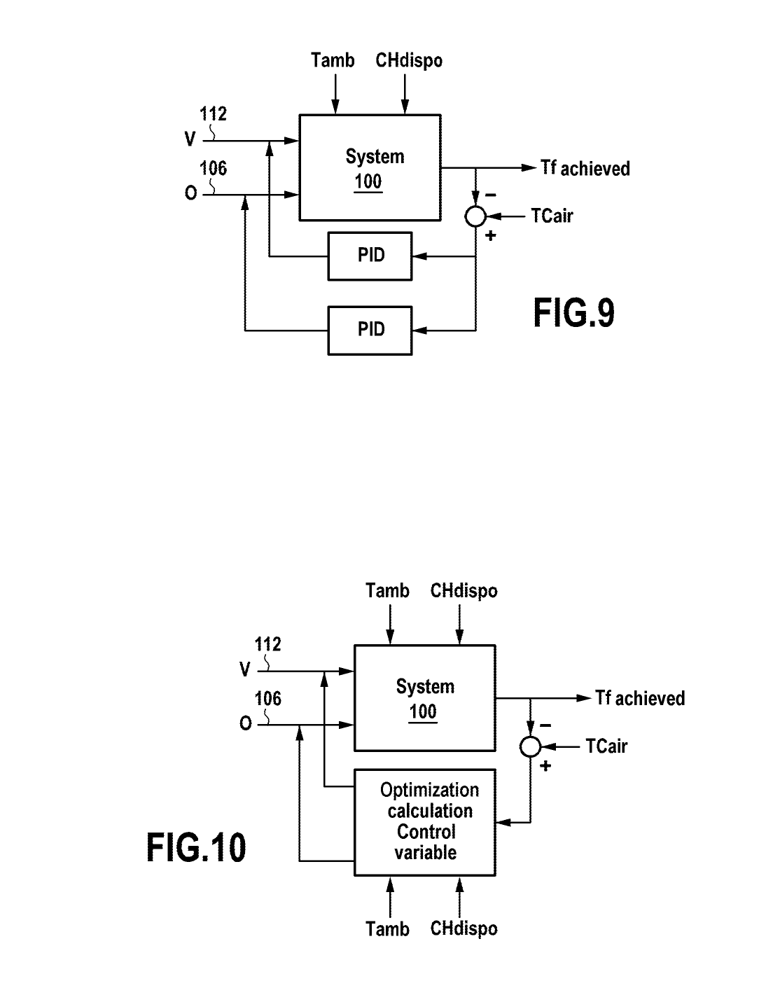

FIGS. 9 to 18 are diagrams showing different regulation methods of the invention applicable to these installations with gas turbines.

To begin with, FIGS. 1 to 8 show a refrigerating machine 100 used within an installation of the invention with a gas turbine.

This refrigerating machine 100 is an ejector system made up of the following elements:
An ejector 102: it acts as a “thermal compressor”. The high pressure stream of a high pressure circuit 110, accelerated at the inlet to the ejector 102 sucks in the low pressure stream of a low pressure circuit 120. These two streams mix in order to form an intermediate pressure stream of an intermediate pressure circuit 130.
The intermediate pressure circuit 130:
   a condenser 104: at the outlet from the ejector 102, the intermediate pressure stream is cooled so as to be condensed. This heat exchange typically takes place with a source at ambient temperature.
The low pressure circuit 120:
   an expander member 106: a portion of this intermediate pressure stream is expanded;
   an evaporator 108: the low pressure stream obtained is heated and evaporated. This low pressure vapor then enters into the ejector 102. This exchange of heat corresponds to the cold that is produced. This exchange of heat takes place with a heat source that is typically at ambient temperature (10° C. to 30° C.)
The high pressure circuit 110:
   a pump 112: the remainder of the intermediate pressure stream is compressed by the pump 112. Since this pump 112 operates on liquid, it consumes little electricity;
   a generator 114: the high pressure stream obtained is heated and evaporated. This high pressure vapor then enters into the ejector 102. This exchange of heat is performed with a heat source typically in the range 80° C. to 120° C.

According to the invention, and as can be seen in FIG. 1, this refrigerating machine 100 is associated with a gas turbine 200, while operating as described above.

The gas turbine 200 comprises a compressor 202, a combustion chamber 204, a turbine 206, and a gas turbine generator 208 suitable for driving the main shaft of the turbine 206 and a compressor 202.

The combustion chamber 204 is fed with fuel by a fuel feed pipe 211.

The exhaust gas from the turbine 206 flows in an exhaust pipe 212.

The air from the air feed pipe 210, which is used for cooling, enters into the gas turbine 200 via the compressor 202 and serves upstream from the gas turbine 200 to evaporate the fluid of the low pressure circuit 120 by passing through the evaporator 108. The fumes leaving the turbine 206 via the exhaust pipe 212, and that need to be cooled, serve to evaporate the high pressure fluid in the generator 114 by exchanging heat in the generator 114. If the installation also includes a co-generation heat exchanger (a configuration that is not shown), then the co-generation heat exchanger is placed upstream from the above-mentioned generator 114 on the exhaust pipe 212.

The fluid from the intermediate pressure circuit 130 is condensed by the condenser 104, which is of the air heater type.

Thus, the installation of the invention cools the air entering via the air feed pipe 210 in the compressor 202 connected to the turbine 206. This air leaves via the compressor and is mixed with a fuel (e.g. natural gas) arriving via the fuel feed pipe 211 in the combustion chamber 204. Combustion then takes place. The combustion gas or “fumes” obtained are expanded in the turbine 206, thereby driving the air compressor 202 and the alternator forming the gas turbine generator 208. The fumes enter into the co-generation heat exchanger, if any, where they are cooled (a configuration not shown in FIG. 1). Thereafter, the fumes cool in the generator 114 of the ejector system formed by the refrigerating machine 100. Finally, the fumes are released to the atmosphere.

This FIG. 1 configuration, in which the exhaust pipe 212 forms the heat source of the high pressure circuit 110 and the air feed pipe 210 is subjected to said first cold source (formed in this example by the evaporator 108), constitutes a first embodiment of the first aspect of the invention.

With reference now to FIGS. 2 to 4, the installation of FIG. 1, formed by the refrigerating machine 100 associated with the gas turbine 200, is configured in another arrangement forming a second embodiment of the first aspect of the invention.

This relates to co-generation: instead of placing the generator 114 directly on the exhaust pipe 212 containing the fumes, the generator 114 is placed on the intermediate water loop 220 between an existing recovery boiler 222 (placed on the exhaust pipe 212 for the fumes) and a client side heat exchanger 224 that is connected to the network for distributing hot water or steam to a client (distribution water loop 226).

Thus, under such circumstances, it can be understood that the installation of the invention also has an intermediate water loop 220 also forming part of said heat source and comprising a recovery boiler 222 through which the exhaust pipe 212 passes, and a heat exchanger 224 (client side heat exchanger) suitable for supplying heat to another distribution water loop 226.

The installation in this second embodiment of the first aspect of the invention can be connected in several variants.

In a first variant, shown in FIG. 2, the connection is said to be “parallel” and the installation further comprises a water pipe 230 connected in parallel with the intermediate water loop 220 at the location of a connection point 231 situated downstream from the recovery boiler 222, passing through the generator 114 in order to form said heat source to which said generator 114 of the refrigerating machine 100 is subjected, and leading to the intermediate water loop 220 downstream from said heat exchanger 224 of the intermediate water loop 220 (connection point 232 in FIG. 2).

Under such circumstances, the temperatures in the intermediate loop 220 remain the same, with only the flow rate of the water being modified. It may be necessary to change the water circulation pump (not shown) of the intermediate loop 220. In contrast, the operating conditions of the client side heat exchanger 224 remain identical to those in the absence of the water pipe 230 forming the parallel connection of the intermediate loop 220.

In a second variant and in a third variant, the connection is said to be a “series” connection.

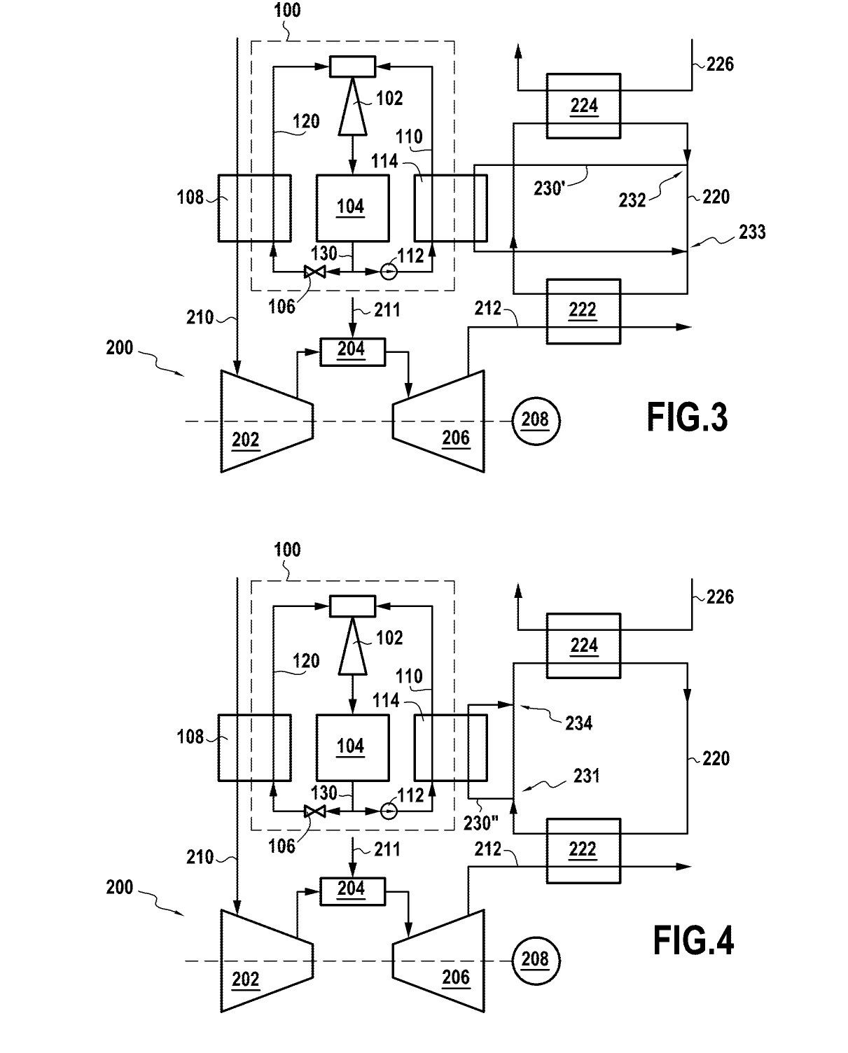

In this second variant, shown in FIG. 3, the installation further includes a water pipe 230′ connected in parallel with the intermediate water loop 220 at the location of a connection point 232 situated downstream from said heat exchanger 224 of the intermediate water loop 220 and passing through the generator 114, in order to form said heat source to which said generator 114 of the refrigerating machine 100 is subjected, and leading into the intermediate water loop 220 downstream from said connection point 232 and upstream from the recovery boiler 222, at a connection point 233.

In this third variant, shown in FIG. 4, the installation further includes a water pipe 230″ connected in parallel with the intermediate water loop 220 at the location of a connection point 231 situated downstream from the recovery boiler 222 and passing through the generator 114 in order to form said heat source to which said generator 114 of the refrigerating machine 100 is subjected, and leading into the intermediate water loop 220 upstream from said heat exchanger 224 of the intermediate water loop 220, at a connection point 234.

In these second and third variants, the temperatures in the intermediate water loop 220 change, while the flow rate may remain identical. The investment required is smaller; however the operating conditions of the client side heat exchanger 224 are modified.

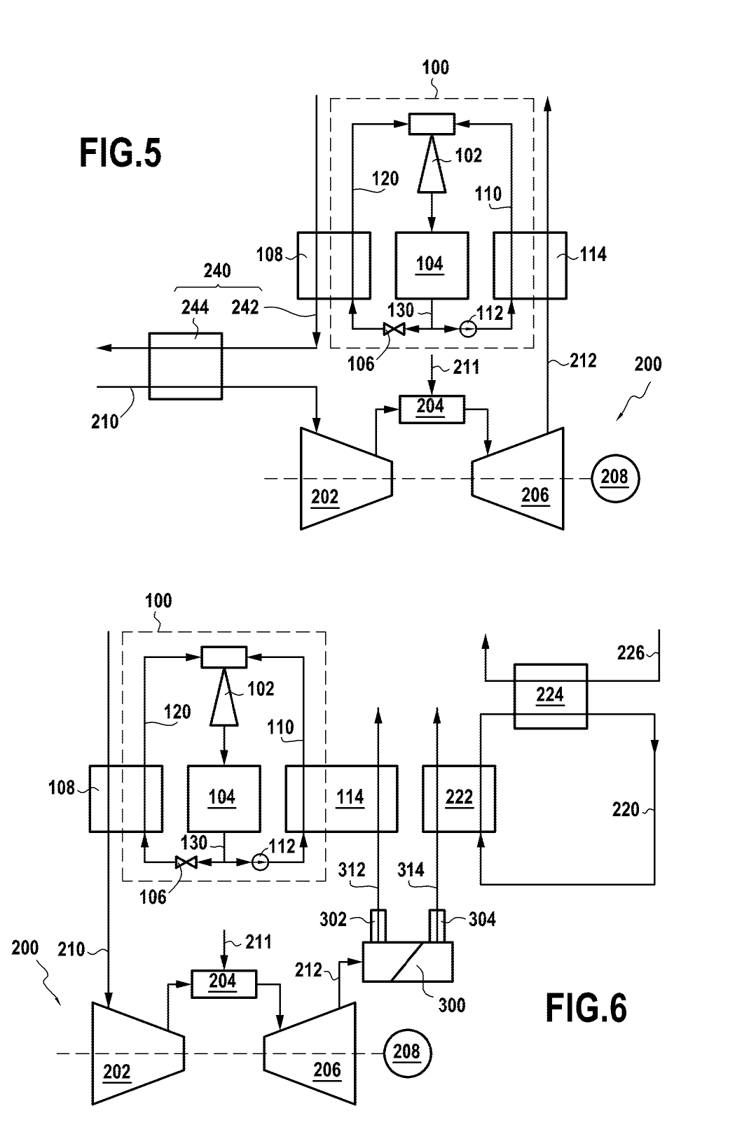

Reference is now made to FIG. 5, which shows an embodiment that is an alternative to the first embodiment of FIG. 1, and that is applicable to the above-described variants of FIGS. 2, 3, and 4.

On certain turbines, particularly on sites where winter temperatures are often cold (close to or less than 0° C.), there exists an anti-icing system that makes it possible when the outside temperature is too low (and when humidity is too high) to heat the air entering the turbine.

Under such circumstances, said gas turbine further includes an anti-icing system 240 forming a second cold source and the air feed pipe 210 is subjected to said second cold source.

In FIG. 5, there can be seen the anti-icing system 240 made up of a water feed pipe 242 and a heat exchanger 244.

Under such circumstances, there already exists a heat exchanger 244 on the air stream at the inlet to the gas turbine 200, i.e. on the air feed pipe 210.

It is also possible for the ejector 102 to make use of this heat exchanger 244 in order to cool air when temperatures are too high (and thus when the anti-icing system 240 is not actually in use): the ejector 102 cools the water passing through this heat exchanger 244 of the anti-icing system 240. The idea is to install the evaporator 108 of the refrigerating machine 100 on the water pipe 242. The water in this water feed pipe is “hot” in winter, so as to prevent air in the pipe 210 icing, and it is cold (i.e. cooled by the refrigerating machine 100) in summer, when the weather is hotter.

This configuration of FIG. 5 may naturally be coupled with the configurations described above with reference to FIGS. 2 to 4.

With numerous gas turbines, there is not a single chimney for discharging exhaust gas, but rather two chimneys. As can be seen in FIGS. 6 to 8, an adjustable valve 300 known as a “diverter” serves to adjust the flow rate from the exhaust pipe 212 via the chimneys 302 and 304. Thus, in present practice, no heat is recovered in the first chimney 302 from which the fumes escape while very hot, but at a flow rate that is often low in the discharge pipe 312 of the first chimney 302.

Thus, at present, heat recovery, in particular for co-generation, takes place in the second chimney 304 via the recovery boiler 222, with flow rates that are greater in the discharge pipe 314 of this second chimney 304. Nevertheless, in this second chimney 304, the fumes then leave at a lower temperature than the fumes leaving the first chimney 302.

Reference is now made to FIGS. 6 to 8 showing possible configurations for using the installation with a gas turbine of the invention (100 and 200) within a heating network comprising a distribution water loop 226 connected to an intermediate water loop 220 by a client side heat exchanger 224 and a recovery boiler 222.

It is then possible to place the ejector system 100 in three different locations:
On the first chimney 302 (FIG. 6): the discharge pipe 312 of the first chimney 302 passes through the generator 114, while the discharge pipe 314 of the second chimney 304 is directed to the recovery boiler 222.

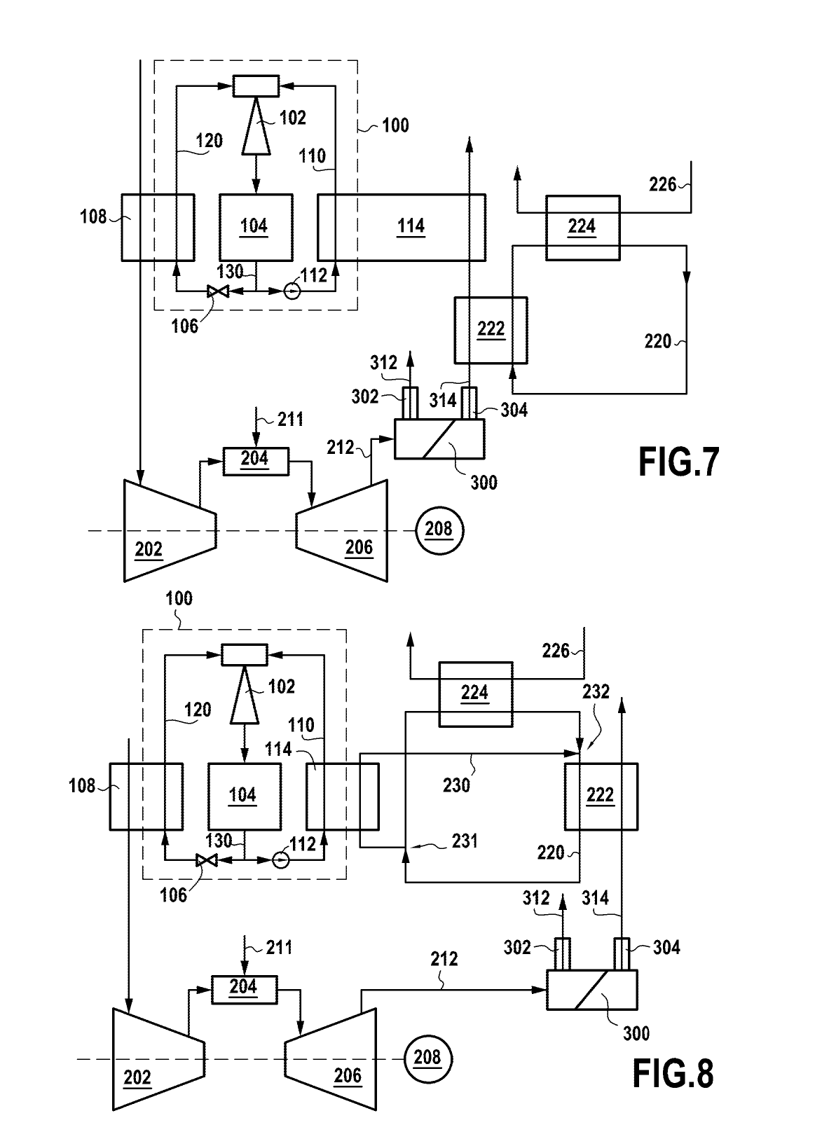

Under such circumstances, the exhaust pipe 212 has at least a first chimney 302 and a second chimney 304 for exhausting fumes, the second chimney being placed downstream from the first chimney with an exhaust control valve 300 being placed between the first chimney 302 and the second chimney 304, and with the fumes leaving the first chimney 302 via the discharge pipe 312 of the first chimney 302, forming said heat source.
On the second chimney 304, after the recovery boiler 222: the ejector system 100 is no longer placed before the recovery boiler 222 in order to avoid being unable to satisfy client needs (the heat used by the ejector system 100 must be heat that is not made use of by the client), as shown in FIG. 7. Under such circumstances, the discharge pipe 314 of the second chimney 304 passes firstly through the recovery boiler 222, and then downstream from the recovery boiler 222 via the generator 114 of the ejector system 100. In this situation, said intermediate water loop 220 forms said heat source since said intermediate water loop 220 is connected via the recovery boiler 222 to the steam generator 114 of the high pressure circuit 110.
On the intermediate hot water loop 220, after the recovery boiler 222: three configurations can then be implemented: in parallel; in series on the go path; and in series on the return path. Only the parallel configuration is shown in FIG. 8: the discharge pipe 314 of the second chimney 304 passes firstly through the recovery boiler 222, which is placed on the intermediate water loop 220 downstream from the client side heat exchanger 224. Under such circumstances and in more general manner, the exhaust pipe 212 includes at least a first chimney 302 and a second chimney 304 for exhausting the fumes, the second chimney 304 being placed downstream from the first chimney 302 with an exhaust adjustment valve 300 between the first chimney 302 and the second chimney 304 via the discharge pipe 314 of the second chimney, and the fumes leaving the second chimney 304 pass through said recovery boiler 222.

In the parallel configuration shown in FIG. 8, there can be seen the water pipe 230 forming a parallel connection with the intermediate water loop 220 at the location of a connection point 231 situated downstream from the recovery boiler 222 and passing through the generator 114 in order to form said heat source to which said generator 114 of the refrigerating machine 100 is subjected, and leading to the intermediate water loop 220 downstream from said heat exchanger 224 of the intermediate water loop 220 (connection point 232 in FIG. 8).

This application makes it possible to make use of heat that is rarely used at present (gas turbine heat at lower than 100° C.), and enables it to be used for increasing the electrical power produced by the turbine 206.

The installation of the present invention is accompanied by optimized regulation enabling it to operate throughout the year (i.e. regardless of outside conditions and of the electricity and heat load constraints imposed on the turbine 206).

In a second aspect of the invention, the Applicant has devised regulation based on experimental results obtained on a prototype that relies on taking account of the heat available in the fumes leaving the gas turbine 200 via the exhaust pipe 212, of a limit of the minimum air temperature authorized at the inlet of the gas turbine 200 in the air feed pipe 210 (minimum value Tf depending on outside conditions), and of an optimized operating model of the ejector system 100.

In general, as can be seen in FIGS. 9 and 10, the ejector system 100 is controlled using two variables: the speed of rotation V of the pump 112 and the degree of opening O of the expander member 106 (solenoid valve).

The control target of the system is to cool the air entering the turbine 206 as much as possible (within the limits of technical conditions required for the turbine 206 to operate), while providing the best possible performance for the ejector system 100, and while taking account of the constraints constituted by ambient temperature Tamb and the heat available in the fumes CHdispo, either in the exhaust pipe 212 (FIGS. 1 to 5), or at the outlet from the chimney 302 or 304 (FIGS. 6 to 8), i.e. in the discharge pipe 312 of the first chimney or in the discharge pipe 314 of the second chimney.

In a first implementation of the second aspect, shown in FIG. 9, there is provided a method of regulating an installation with a gas turbine as described above, wherein regulating said refrigerating machine (ejector system 100) by regulating the speed V of said pump 112 and the level of opening (O) of said expander member 106, on the basis of a setpoint temperature (TCair) for the air in said air feed pipe 210 situated downstream from the cold source (Tf), i.e. at the inlet to the compressor 202, by using two PID regulators.

Under such circumstances, it is necessary to decorrelate the influences of the two input parameters (here the speed V of the pump 112 and the opening O of the expander member 106), and to use a PID regulator on each input, namely a first PID regulator 402 at the input from the pump 112 in order to adjust its speed V, and a second PID regulator 404 at the input from the expander member 106 in order to adjust its degree of opening O.

In a second implementation of the second aspect, shown in FIG. 10, there is provided a method of regulating an installation with a gas turbine as described above, wherein the following step is performed: regulating said refrigerating machine 100 by regulating the speed V of said pump 112 and the level of opening O of said expander member 106, from a setpoint temperature (TCair) for the air in said air feed pipe 210 situated downstream from the cold source (Tf), by using an optimized and/or robust multivariable command taking into consideration the temperature of ambient air Tamb, the heat available in the exhaust gas CHdispo (energy in Joules (J) or power in Watts (W)) and the real temperature of the air in the air feed pipe 210 at the inlet to the compressor 202 (Tf achieved). This thus involves optimizing input values for the ejector system 100.

Thus, this type of ejector system 100 can be regulated for example by using a multivariable command based on a model of the operation of the system. The regulation then consists in optimizing input values (speed V of the pump 112 and opening O of the expander member 106) with knowledge of the values measured at the outlet (cooled air temperature, Tf achieved) and of constraints (outside temperature, Tamb, and heat available in the fumes, CHdispo).

The optimization calculation consists in inverting the model selected for representing the ejector system 100.

This model may have various different forms:
a set of charts associating the performance of the system and the cooled air temperature Tf achieved with the outside temperature Tamb, the heat available in the fumes CHdispo, the speed V of the pump 112, and the opening O of the expander member 106;
a model identified from a (sufficiently large) set of measurements performed on the ejector system 100. This model may be in the form of equations of state; and
a deterministic model, i.e. a set of equations (and a calculation algorithm) associating the various parameters (in particular Tf achieved, Tamb, CHdispo, V and O, . . . ). This model is often expressed in the form of equations of state.

The solution selected from among these three possibilities depends on the available data, on the frequency with which the necessary input values are refreshed, and on the possibility or impossibility of obtaining deterministic physical models. These solutions require longer or shorter calculation times: for example, the use of charts enables calculation to be performed very quickly (in a few seconds), whereas the use of a deterministic model requires much more time (up to several minutes).

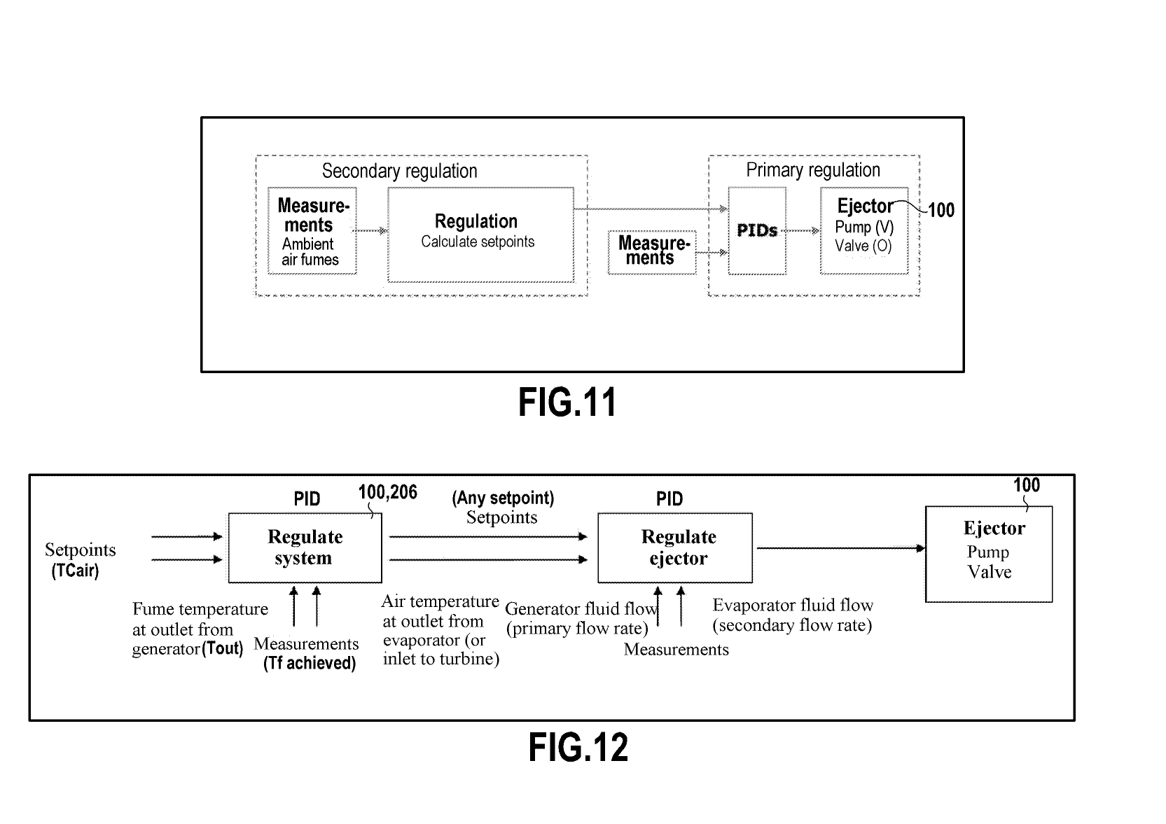

In a third implementation of the second aspect, shown in FIG. 11, there is provided a method of regulating an installation with a gas turbine as described above in the second embodiment of the second aspect, wherein the following steps are performed: primary regulation of said refrigerating machine 100 by regulating (e.g. using PIDs) the speed V of said pump 112 and the level of opening O of said expander member 106 on the basis of the setpoints for at least two primary regulation parameters selected from parameters of the refrigerating machine 100 comprising the temperature of the fluid during the change of state in the evaporator (Tevap), the temperature of the fluid during the change of state in the generator (Tg), the flow rate of the fluid in the low pressure circuit (m1 or primary flow rate), the flow rate of fluid in the high pressure circuit (m2 or secondary flow rate), the difference (Lift) between the temperature during the change of state in the condenser (Tcond) and during the change of state in the evaporator (Tevap), and the ratio between the flow rate of the fluid (m1) in the low pressure circuit 110 and the flow rate of the fluid (m2) in the high pressure circuit 120 (referred to as the entrainment rate w); and
secondary regulation of said refrigerating machine 100 by using a regulator system to calculate the setpoint values for said selected primary regulation parameters.

The “primary” regulation, which can also be referred to as “low level regulation”, serves to control directly the pump 112 (speed V) and the expander member 106 (level of opening O of the expander member 106, which is generally a valve). The outputs from the primary regulation are thus control magnitudes, specifically the speed (V) for the pump 112 and the level of opening (O) for the expander member 106. As input data, the primary regulation uses two measurements and two setpoints calculated by the “secondary” regulation. These two measurements and these two setpoints must correspond to the same pair of parameters. For example, if one of the setpoints is the evaporation temperature Tevap, this temperature needs to be measured. It is also possible to use a mathematical tool (referred to as an “observer”) that makes it possible to deduce the current value of the evaporation temperature from other measurements. When use is made of lift (Tcond−Tevap) and/or of the entrainment rate (w=m2/m1), it is essential to have an observer (since it is not possible to measure those magnitudes directly).

The definition of this primary regulation needs to incorporate a (simple) model associating the measured magnitudes with the speed (V) of the pump 106 and with the opening (O) of the expander member 106.

By using measurements of the constraints imposed on the system comprising the gas turbine 200 and the refrigerating machine 100, the “secondary” regulation serves to calculate the setpoints for the “primary” regulation.

FIG. 12 shows a variant of the third implementation of the second aspect, wherein the regulator system of the second regulation is a PID regulator system based on a setpoint temperature (TCair) for the air in said air feed pipe 210 situated downstream from the cold source, i.e. at the inlet of the compressor 202.

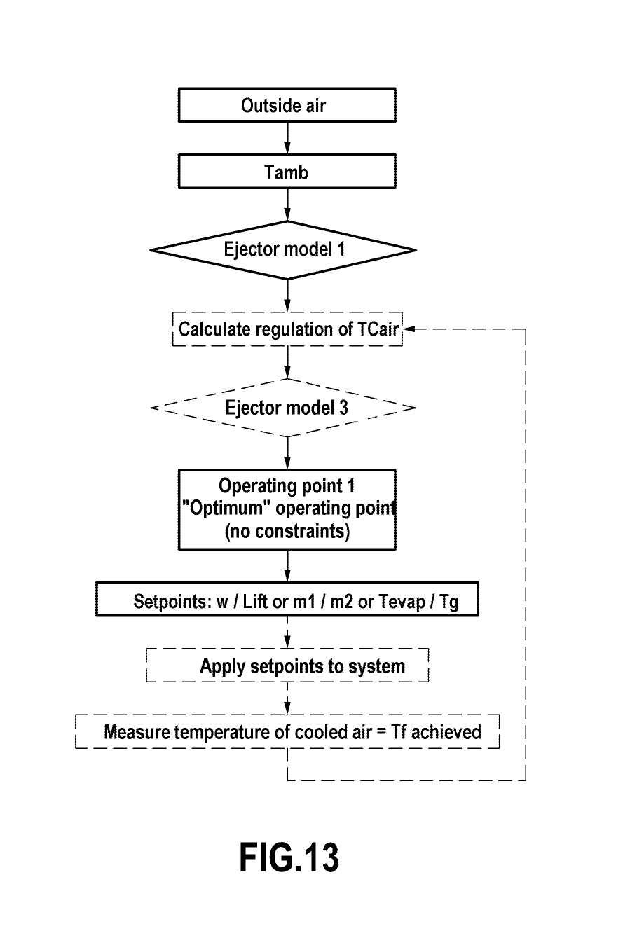

In FIGS. 13 to 18:
“inputs” designate the measurements or the data needed for the regulation to operate;
“outputs” designate the results obtained, as used herein as setpoints for regulating the ejector (primary regulation); and
“correlations” designate experimental or bibliographic data associating outside humidity Hamb with the minimum safe temperature that will ensure there is no icing in the turbine (minimum Tf).

In a fourth implementation of the second aspect, shown in continuous lines in FIG. 13, there is provided a method of regulating an installation with a gas turbine as described above in the third embodiment of the second aspect, wherein the regulator system of the secondary regulation includes a first mathematical model of the ejector system 100 that supplies the setpoint for the fluid flow rate at the output from the generator (optimum m1) on the basis of a first series of magnitudes including the temperature of ambient air Tamb.

The first model calculates the optimum point, i.e. without any constraint being taken into account. The only input data is the outside temperature Tamb (or the water condensation temperature, which depends directly on the outside temperature Tamb).

In a variant of the fourth implementation of the second aspect, shown in FIG. 13 with additional elements in dashed lines, there is provided a method of regulating an installation with a gas turbine as described above, wherein the regulator system of the secondary regulation further includes a third mathematical model of the ejector system (100), referred to as the “ejector model 3”, situated downstream from the first mathematical model of the ejector system referred to as the “ejector model 1”, that provides various items of information about the optimum operating point of the installation from a third series of magnitudes comprising the real temperature of the air in the air feed pipe 210 at the inlet to the compressor 202 (Tf achieved), and the setpoint temperature (TCair) for the air in said air feed pipe 210 calculated by the first mathematical model.

Under such circumstances, a regulation calculation (e.g. a PID calculation) is thus added to the output from the first model of the ejector in order to take account of the difference between the real temperature of the air in the air feed pipe (210) at the inlet to the compressor (202) after cooling (Tf achieved), and the setpoint temperature (TCair) as calculated by the first mathematical model.

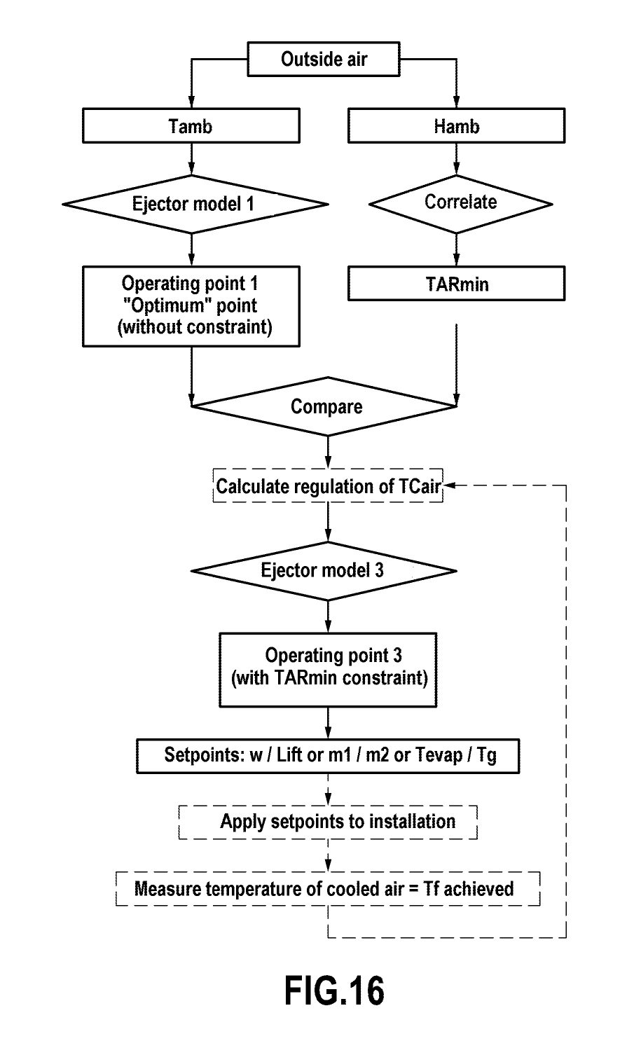

In another variant of the fourth implementation of the second aspect, shown in continuous lines in FIG. 16, there is provided a method of regulating an installation with a gas turbine as described above in the third embodiment of the second aspect, wherein the regulator system of the secondary regulator also takes account of the humidity of the ambient air Hamb in order to determine the minimum value of the temperature of the air in the air feed pipe 210 at the inlet to the compressor (minimum Tf), and the regulator system of the secondary regulation further includes a third mathematical model of the ejector system 100 that provides various items of information about the optimum operating point of the installation from a third series of magnitudes including the real temperature of the air in the air feed pipe 210 at the inlet to the compressor (Tf achieved), and the minimum acceptable temperature for air at the inlet to the turbine 206 (TARmin).

The third model calculates the operation of the system by taking account of the limit temperature for cooling air (which may be fixed or calculated), or more generally the minimum air temperature that is acceptable at the inlet of the turbine (TARmin). As input data it uses: the operation of the ejector system 100 without this constraint (i.e. the result of the first model and in particular the cooled air temperature that is achieved depending on the operating point of the first model of the ejector, i.e. Tf achieved), and the limit cooling temperature for air TARmin.

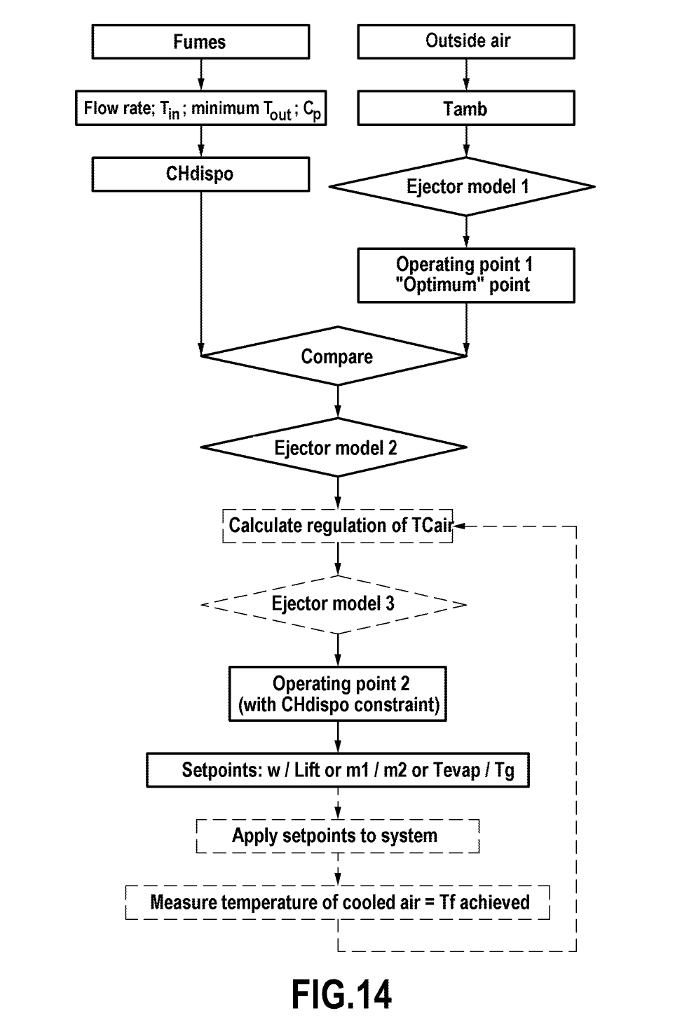

In a fifth implementation of the second aspect, shown in FIG. 14 in continuous lines, there is provided a method of regulating an installation with a gas turbine as described above for the fourth embodiment of the second aspect, wherein the regulator system of the secondary regulation also takes account of magnitudes representative of the exhaust gas (such as the input temperature and/or the flow rate and/or the heat capacity) and further includes a second mathematical model of the ejector system 100, referred to as the “ejector model 2”, that supplies an optimum value for the temperature of the air in the air feed pipe at the inlet to the compressor (optimum Tf), on the basis of a second series of magnitudes comprising the heat available in the exhaust gas (CHdispo), the temperature of the fluid in the condenser (Tcond), and the flow rate of the fluid at the outlet from the generator (m1 achieved).

The second mathematical model calculates the second operating point of the system by taking account of the heat available in the exhaust gas CHdispo. It uses the following input data: the operation of the ejector system 100 without constraint (i.e. the result from the first model), and the heat available in the exhaust gas (CHdispo) (exhaust pipe 212). To do this, upstream from this second mathematical model, a comparison is made between the heat consumed at the first operating point of the system and the maximum possible power, namely the heat that is actually available in the exhaust gas (fumes) CHdispo.

In a first variant of the fifth implementation of the second aspect, shown in FIG. 14 with additional elements in dashed lines, there is provided a method of regulating an installation with a gas turbine as described above, wherein the regulator system of the secondary regulation further includes a third mathematical model of the ejector system (100), situated downstream from the second mathematical model of the ejector system, and providing various items of information about the optimum operating point of the installation from a third series of magnitudes comprising the real temperature of the air in the air feed pipe (210) at the inlet to the compressor (202) (Tf achieved), and the setpoint temperature (TCair) for the air in said air feed pipe 210 as calculated by the first mathematical model.

Under such circumstances, a regulation calculation (e.g. a PID calculation) is thus added to the output from the second model of the ejector, for the purpose of taking account of the difference between the real temperature of the air in the air feed pipe (210) at the inlet to the compressor (202) after cooling (Tf achieved), and the setpoint temperature (TCair) calculated by the second mathematical model.

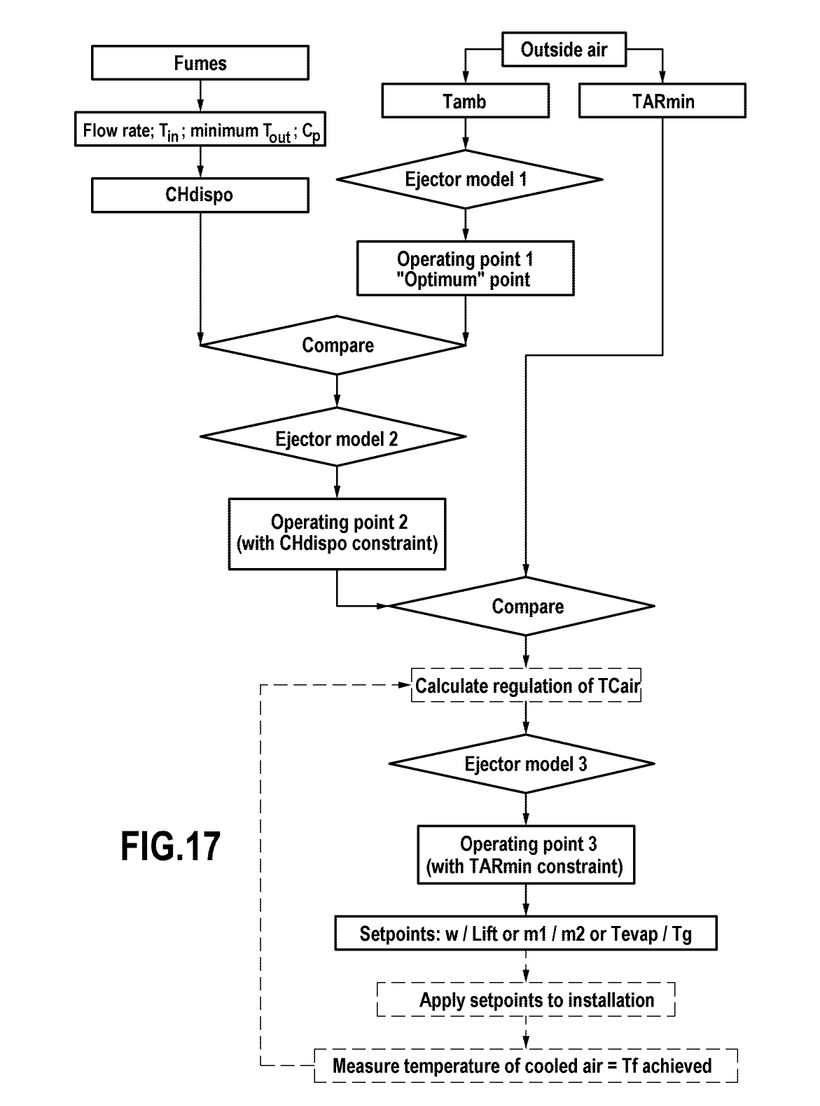

In a second variant of the fifth implementation of the second aspect, shown in continuous lines in FIG. 17, there is provided a method of regulating an installation with a gas turbine as described above with reference to FIG. 14 and in the fifth embodiment of the second aspect, wherein the regulator system of the secondary regulation also takes account of a predetermined minimum value for the temperature of the air in the air feed pipe 210 at the inlet to the compressor 202 (minimum Tf) and the greater of said optimum value for the temperature of the air in the air feed pipe 210 at the inlet to the compressor 202 (fixed optimum Tf) and a predetermined minimum value for the temperature of the air in the air feed pipe 210 at the inlet to the compressor 202 (minimum Tf), said greater value being the greater of optimum Tf and minimum Tf and forming the real temperature of the air in the air feed pipe 210 at the inlet of the compressor 202 (Tf achieved), and wherein the regulator system of the secondary regulation further includes a third mathematical model of the ejector system 100 that supplies various items of information about the optimum operating point of the installation from a third series of magnitudes comprising the real temperature of the air in the air feed pipe 210 at the inlet to the compressor (Tf achieved), and the minimum acceptable air temperature at the inlet of the turbine 206 (TARmin).

It should be observed that in most circumstances TARmin=minimum Tf and corresponds to the temperature of the air after being cooled by the ejector system (refrigerating machine 100): TARmin is the minimum acceptable temperature for the cooled air at the inlet to the turbine 206, and minimum Tf is the predetermined minimum value for the temperature of the air in the air feed pipe 210 at the inlet to the compressor 202.

The second mathematical model calculates the first operating point of the system by taking account of the available heat CHdispo. As input data it uses the following: the operation of the ejector system 100 without this constraint (i.e. the result from the first model), and the heat available in the exhaust gas (CHdispo) (exhaust pipe 212). To do this, upstream from the second mathematical model, a comparison is made between the heat consumed at the first operating point of the system with the maximum possible power, namely the heat actually available in the exhaust gas (fumes) CHdispo.

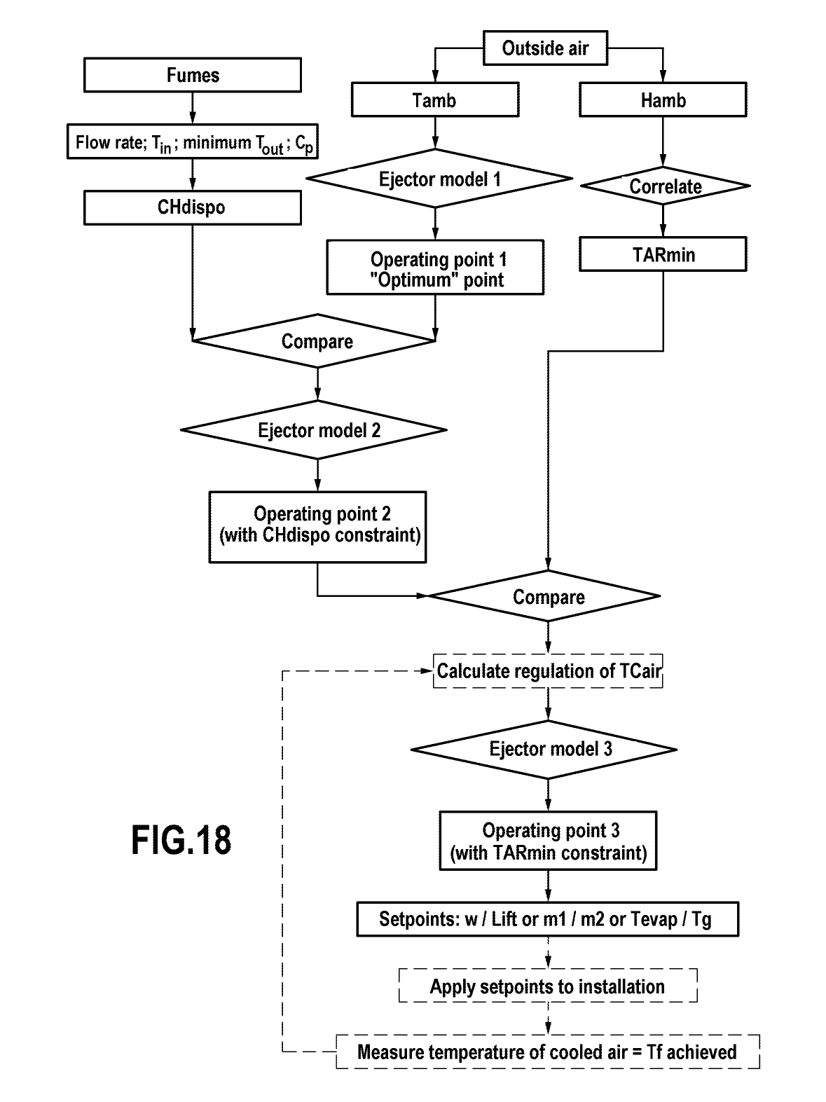

In a third variant of the fifth implementation of the second aspect, shown in continuous lines in FIG. 18, there is provided a method of regulating an installation with a gas turbine as described above, wherein the regulator system of the secondary regulation also takes account of the humidity Hamb of ambient air in order to determine the minimum value for the temperature of the air in the air feed pipe 210 at the inlet of the compressor 202 (minimum Tf), and the greater of said optimum value for the temperature of the air in the air feed pipe 210 at the inlet of the compressor 202 (optimum TF) and a predetermined minimum value for the temperature of the air in the air feed pipe 210 at the inlet of the compressor 202 (fixed minimum Tf), said greater value being the greater value of optimum Tf and of minimum Tf and forming the real temperature of the air in the air feed pipe 210 at the inlet of the compressor 202 (Tf achieved), and wherein the regulator system of the secondary regulation further includes a third mathematical model of the ejector system 100 that supplies various items of information about the optimum operating point of the installation from a third series of magnitudes comprising the real temperature of the air in the air feed pipe 210 at the inlet of the compressor 202 (Tf achieved), and the minimum acceptable temperature for the air at the inlet of the turbine 206 (TARmin).

The second mathematical model calculates the second operating point of the system while taking account of the available heat CHdispo. As input data it uses the following: the operation of the ejector system 100 without this constraint (i.e. the result from the first model), and the available heat in the exhaust gas (CHdispo) (exhaust pipe 212). To do this, upstream from the second mathematical model, a comparison is made between the heat consumed at the first operating point of the system and the maximum possible power, i.e. the heat actually available in the exhaust gas (fumes) CHdispo.

In an alternative of the second or third variant of the fifth implementation of the second aspect, there is provided a method of regulating an installation with a gas turbine as described above, wherein said items of information about the optimum operating point of the installation comprise at least one item selected from: the fluid flow rate at the outlet from the evaporator 108 (m2 achieved); the ratio (w) between the fluid flow rate at the outlet of the evaporator 108 (m2 achieved) and the fluid flow rate at the outlet from the generator 114 (m1 achieved); the change of state temperature of the evaporator 108 (Tevap); the difference (Lift) between the change of state temperature of the condenser 104 (Tcond) and the change of state temperature of the evaporator 108 (Tevap); the pressure at the generator 114 (Pg); and the pressure at the evaporator 108 (Pevap).

Thus, as can be seen in FIG. 18:
the second mathematical model calculates the second operating point of the system while taking account of the available heat CHdispo. As input data it uses the following: the operation of the ejector system 100 without constraint (i.e. the result from the first model), and the heat available in the exhaust gas (CHdispo) (exhaust pipe 212). To do this, upstream from the second mathematical model, a comparison is made between the heat consumed at the first operating point of the system and the maximum possible power, i.e. the heat actually available in the exhaust gas (fumes) CHdispo; and
the third model, located downstream from the second model, calculates the operation of the system while taking account of the limit temperature for cooling air (which may be fixed or calculated), or more generally of the minimum air temperature acceptable at the inlet of the turbine (TARmin). As input data it uses the following: the operation of the ejector system 100 without the constraint of the heat actually available in the exhaust gas CHdispo (and thus the result from the second model), and the limit temperature for cooling air TARmin.

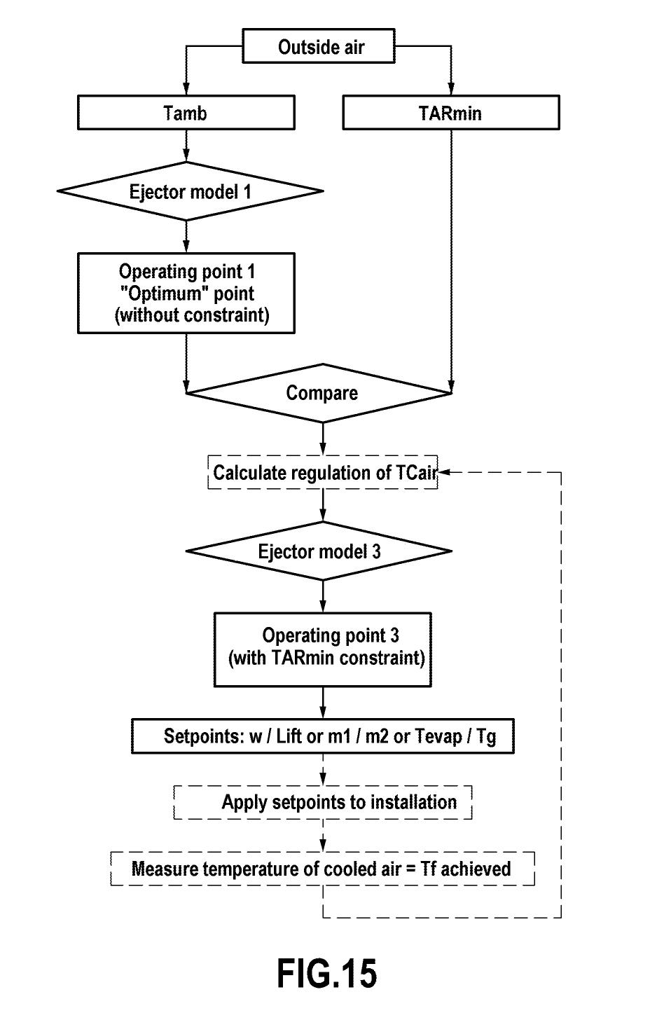

In a sixth implementation of the second aspect, shown in FIG. 15 in continuous lines, there is provided a method of regulating an installation with a gas turbine as described above in the fourth embodiment of the second aspect, wherein the regulator system of the secondary regulation also takes account of a predetermined minimum value for the air temperature in the air feed pipe at the inlet to the compressor (minimum Tf), and wherein the regulator system of the secondary regulation also includes a third mathematical model of the ejector system 100 that provides various items of information about the optimum operating point of the installation from a third series of magnitudes comprising the real temperature of the air in the air feed pipe at the inlet to the compressor (Tf achieved), and the minimum acceptable temperature for air at the inlet to the turbine (TARmin).

The third model calculates the operation of the system by taking account of the limit temperature for cooling air (which may be fixed or calculated), or more generally the minimum acceptable temperature for air at the inlet to the turbine (TARmin). As input data it uses the following: the operation of the ejector system 100 without this constraint (i.e. the result from the first model or from the second model and in particular the achieved cooled air temperature depending on the operating point of the first model of the ejector, i.e. Tf achieved) and the limit temperature for cooling air TARmin.

Constraints are taken into account by making a comparison between the previously calculated operating points and the constraint in question.

For example, in the second model, it is verified whether the heat consumed by the ejector system 100 without constraint (i.e. the result from the first model) is less than the heat available CHdispo. If not, the operation of the system should be restricted in order to reduce its heat consumption: the constraint acts firstly on the primary flow rate ml.

Likewise, in the third model, it is verified whether the temperature of the cold produced in the ejector system 100 without this constraint (optimum Tf, the result of the first or second model) is greater than the limit temperature (TARmin). If not, the operation of the ejector system 100 is restrained in order to reduce the production of cold: this increases the temperature of the cold that is produced (Tf achieved), and decreases the secondary flow rate m2.

Preferably, two setpoint values (or items of information about setpoint values) are used: one on the side of the generator 114 and another on the side of evaporator 108. Generally, but not necessarily, the variables used are of the same type: two temperatures (Tevap and thus Tg) or two pressures (Pevap and Pg) or two flow rates (m1 and m2).

The lift (Tcond−Tevap) and the entrainment rate (w=m2/m2) are “performance indicators” that, when used together, contain sufficient information to act as setpoint variables.

In an alternative implementation of the second aspect of the invention, applicable to the regulation methods described above with reference to FIGS. 13 to 18, said third mathematical model of the ejector system (100) is corrected by adding to the optimum operating point of the installation the difference between the real temperature of the air in the air feed pipe (210) at the inlet of the compressor (202) after cooling (Tf achieved) and the setpoint temperature (TCair) calculated by the third mathematical model, and taking account of the minimum acceptable temperature for air at the inlet of the turbine (206) (TAR min).

As can be seen in FIGS. 13 to 18, when considering elements drawn in dashed lines, prior to the first ejector model there is added a return of the measurements of the temperature of the cooled air (Tf achieved) resulting from applying setpoints previously established for the installation in the first aspect of the invention, made up of the installation with a gas turbine 200 and the refrigerating machine 100, by using a regulation calculation (e.g. a PID calculation) that supplies the setpoint temperature (TCair) to the input of the third model of the ejector.

This additional provision in a closed loop serves to correct the regulations described with reference to FIGS. 13 to 18 that do not involve the elements drawn in dashed lines, which have the feature of being in open loop configuration: in other words there is no return about the real operation of the installation in the first aspect of the invention as formed by the assembly comprising the gas turbine 200 and the refrigerating machine 100. Thus, by this additional provision, the system is prevented from drifting or the first and/or second mathematical model of the refrigerating machine 100 forming the ejector system is/are prevented from becoming wrongly calibrated, thereby avoiding regulation errors, and thus making it possible to reach the desired operating point.

In order to evaluate the improvements obtained by such a system, calculations have been performed on data corresponding to various different climates for a 4.5 megawatts (MW) turbine.

Those calculations relied on several assumptions:
air humidity is not taken into account;
the heat capacity of dry air is constant with varying temperature;
the cost of the ejector system varies linearly with the “cold” power to be supplied;
the electricity consumption of the ejector varies linearly with the “cold” power supplied;
the power lost by the turbine due to load losses in the evaporator depends on the cooling performed and on the power of the turbine;
the flow rate of air for cooling varies linearly with consumption of natural gas; and
the system is regulated using the method described above with reference to FIG. 18.

Those calculations show that it is possible to obtain an improvement of about 2.1% compared with the power without CTIAC on such a turbine for operation from November to March (from 0.4% to 8.6% depending on atmospheric conditions) or of 5.1% over an entire year (from 3% to 10.5% depending on atmospheric conditions). The ejector system (refrigerating machine 100) consumes about 5.3% of the resulting power saving.

Those results were obtained for several different atmospheric conditions: wet or dry, hot or temperate. Our calculations show that the invention is advantageous whatever the climatic conditions: whether in Abu Dhabi, Marseille, Bucharest, or Warsaw.

The results obtained also show:
energy consumption that is higher than an absorption system but lower than a mechanical compression system;
an improvement that is comparable to an absorption system or to a mechanical compression system; and
the performance of the system depends little on outside conditions: the system presents good performance regardless of the atmospheric conditions under consideration. Specifically, the performance of the system, in particular its thermal coefficient of performance (COP), and its electrical performance remain fairly constant for all outside conditions (because of the optimum regulation that is applied). The differences in improvements in electrical power are due more to the potential improvement associated with atmospheric conditions and with the performance of the system itself: any CTIAC system is more advantageous in a hot climate than in a cold climate.

1. A gas turbine installation, the installation comprising:
a refrigerating machine operating with a fluid and comprising:
a high pressure circuit with a generator fed by a pump and subjected to a heat source;
a low pressure circuit with an evaporator fed by an expander member and forming a first cold source; and
an intermediate pressure circuit with an ejector and a condenser placed downstream from said ejector;
wherein the fluid leaving the generator and the fluid leaving the evaporator feed said ejector and the fluid leaving the condenser feeds said pump and said expander member; and
a gas turbine with a compressor fed with air by an air feed pipe and having its outlet connected to the inlet of a combustion chamber fed with fuel, the output from the combustion chamber being connected to the inlet of a turbine presenting an outlet with exhaust gas flowing in an exhaust pipe;
wherein the air feed pipe is subjected to a cold source and the exhaust pipe forms part of said heat source.

2. The gas turbine installation according to claim 1, which also includes an intermediate water loop forming part of said heat source and including a recovery boiler though which the exhaust pipe passes, and a heat exchanger suitable for supplying heat to another water loop for distribution.

3. The gas turbine installation according to claim 2, which further comprises a water pipe connected in parallel with the intermediate water loop at the location of a connection point situated downstream from the recovery boiler, passing through the generator in order to form said heat source to which said generator of the refrigerating machine is subjected, and leading to the intermediate water loop downstream from said heat exchanger of the intermediate water loop.

4. The gas turbine installation according to claim 2, which further includes a water pipe connected in parallel with the intermediate water loop at the location of a connection point situated downstream from said heat exchanger of the intermediate water loop and passing through the generator in order to form said heat source to which said generator of the refrigerating machine is subjected, and leading into the intermediate water loop downstream from said connection point and upstream from the recovery boiler.

5. The gas turbine installation according to claim 2, which further includes a water pipe connected in parallel with the intermediate water loop at the location of a connection point situated downstream from the recovery boiler and passing through the generator in order to form said heat source to which said generator of the refrigerating machine is subjected, and leading into the intermediate water loop upstream from said heat exchanger of the intermediate water loop.

6. The gas turbine installation according to claim 1, wherein said gas turbine includes an anti-icing system forming a second cold source, and in that the air feed pipe is subjected to said second cold source.

7. An installation according to claim 1, wherein the air feed pipe is subjected to said first cold source.

8. The gas turbine installation according to claim 1, wherein the exhaust pipe includes at least a first chimney and a second chimney for exhausting fumes, the second chimney being placed downstream from the first chimney with an exhaust adjustment valve between the first chimney and the second chimney, and in that the fumes leaving the first chimney form said heat source.

9. The gas turbine installation according to claim 2, wherein said intermediate water loop form said heat source.

10. The gas turbine installation according to claim 3, wherein the exhaust pipe includes at least a first chimney and a second chimney for exhausting the fumes, the second chimney being placed downstream from the first chimney with an exhaust adjustment valve between the first chimney and the second chimney, and in that the fumes leaving the second chimney pass through said recovery boiler.

11. A regulation method for regulating an installation with a gas turbine according to claim 1, including the step of:
regulating said refrigerating machine by regulating the speed of said pump and the level of opening of said expander member, on the basis of a setpoint temperature for the air in said air feed pipe situated downstream from the cold source, by using two PID regulators.

12. A regulation method for regulating an installation with a gas turbine according to claim 1, wherein the following step is performed:
regulating said refrigerating machine by regulating the speed of said pump and the level of opening of said expander member, from a setpoint temperature for the air in said air feed pipe situated downstream from the cold source, by optimizing a multivariable command taking into consideration the temperature of ambient air, the heat available in the exhaust gas, and the real temperature of the air in the air feed pipe at the inlet to the compressor.

13. A regulation method for regulating an installation with a gas turbine according to claim 1, wherein the following steps are performed:
primary regulation of said refrigerating machine by regulating the speed of said pump and the level of opening of said expander member on the basis of the setpoints for at least two primary regulation parameters selected from parameters of the refrigerating machine comprising the temperature of the fluid during the change of state in the evaporator, the temperature of the fluid during the change of state in the generator, the flow rate of the fluid in the low pressure circuit, the flow rate of fluid in the high pressure circuit, the difference between the temperature during the change of state in the condenser and during the change of state in the evaporator, and the ratio between the flow rate of the fluid in the low pressure circuit and the flow rate of the fluid in the high pressure circuit; and
secondary regulation of said refrigerating machine by using a regulator system to calculate the setpoint values for said selected primary regulation parameters.

14. The regulation method according to claim 13, wherein the regulator system of the second regulation is a PID regulator system based on a setpoint temperature for the air in said air feed pipe situated downstream from the cold source.

15. A regulation method according to claim 13, wherein the regulator system of the secondary regulation includes a first mathematical model of the ejector system that supplies the setpoint for the fluid flow rate at the output from the generator on the basis of a first series of magnitudes including the temperature of ambient air.

16. The regulation method according to claim 15, wherein the regulator system of the secondary regulation also takes account of magnitudes representative of the exhaust gas and further includes a second mathematical model of the ejector system that supplies an optimum value for the temperature of the air in the air feed pipe at the inlet to the compressor, on the basis of a second series of magnitudes comprising the heat available in the exhaust gas, the temperature of the fluid in the condenser, and the flow rate of the fluid at the outlet from the generator.

17. The regulation method according to claim 15, wherein the regulator system of the secondary regulation further includes a third mathematical model of the ejector system that provides various items of information about the optimum operating point of the installation from a third series of magnitudes comprising the real temperature of the air in the air feed pipe at the inlet to the compressor, and the setpoint temperature for the air in said air feed pipe calculated by the first mathematical model.

18. The regulation method according to claim 15, wherein the regulator system of the secondary regulator also takes account of a predetermined minimum value for the temperature of the air in the air feed pipe at the inlet to the compressor, and wherein the regulator system of the secondary regulation further includes a third mathematical model of the ejector system that provides various items of information about the optimum operating point of the installation from a third series of magnitudes including the real temperature of the air in the air feed pipe at the inlet to the compressor, and the minimum acceptable temperature for air at the inlet to the turbine.

19. The regulation method according to claim 15, wherein the regulator system of the secondary regulator also takes account of the humidity of the ambient air in order to determine the minimum value of the temperature of the air in the air feed pipe at the inlet to the compressor, and the regulator system of the secondary regulation further includes a third mathematical model of the ejector system that provides various items of information about the optimum operating point of the installation from a third series of magnitudes including the real temperature of the air in the air feed pipe at the inlet to the compressor, and the minimum acceptable temperature for air at the inlet to the turbine.

20. The regulation method according to claim 16, wherein the regulator system of the secondary regulation also takes account of a predetermined minimum value for the temperature of the air in the air feed pipe at the inlet to the compressor and the greater of said optimum value for the temperature of the air in the air feed pipe at the inlet to the compressor and a predetermined minimum value for the temperature of the air in the air feed pipe at the inlet to the compressor, said greater value forming the real temperature of the air in the air feed pipe at the inlet of the compressor, and wherein the regulator system of the secondary regulation further includes a third mathematical model of the ejector system that supplies various items of information about the optimum operating point of the installation from a third series of magnitudes comprising the real temperature of the air feed pipe at the inlet of the compressor, and the minimum acceptable temperature for the air at the inlet of the turbine.

21. The regulation method according to claim 16, wherein the regulator system of the secondary regulation also takes account of the humidity of ambient air in order to determine the minimum value for the temperature of the air in the air feed pipe at the inlet of the compressor, and the greater of said optimum value for the temperature of the air in the air feed pipe at the inlet of the compressor and a predetermined minimum value for the temperature of the air in the air feed pipe at the inlet of the compressor, said greater value forming the real temperature of the air in the air feed pipe at the inlet of the compressor, and wherein the regulator system of the secondary regulation further includes a third mathematical model of the ejector system that supplies various items of information about the optimum operating point of the installation from a third series of magnitudes comprising the real temperature of the air in the air feed pipe at the inlet of the compressor, and the minimum acceptable temperature for the air at the inlet of the turbine.

22. The regulation method according to claim 20, wherein said items of information about the optimum operating point of the installation comprise at least one item selected from: the fluid flow rate at the outlet from the evaporator, the ratio between the fluid flow rate at the outlet of the evaporator and the fluid flow rate at the outlet from the generator, the change of state temperature of the evaporator, the difference between the change of state temperature of the condenser and the change of state temperature of the evaporator; the pressure at the generator, and the pressure at the evaporator.

23. The regulation method according to claim 18, wherein said third mathematical model of the ejector system is corrected by adding to the optimum operating point of the installation the difference between the real temperature of the air in the air feed pipe at the inlet of the compressor after cooling and the setpoint temperature calculated by the third mathematical model, and taking account of the minimum acceptable temperature for air at the inlet of the turbine.
